(19) United States
(12) Patent Application Publication
(10) Pub. No.: US 2021/0231099 A1
(43) Pub. Date: Jul. 29, 2021

(54) METHOD FOR MANUFACTURING A WIND POWER PLANT ROTOR BLADE

(71) Applicant: Wobben Properties GmbH, Aurich (DE)

(72) Inventors: Christina Bärtl, Aurich (DE); Karsten Voigt, Lostau (DE)

(21) Appl. No.: 17/143,772

(22) Filed: Jan. 7, 2021

(30) Foreign Application Priority Data
Jan. 9, 2020 (DE) 102020100275.0

(51) Int. Cl. F03D 1/06; B29C 70/44

(52) U.S. Cl. CPC F03D 1/0675; B29C 70/443; F05B 2240/30; B29L 2031/085; F05B 2280/6013; F05B 2280/6003; F05B 2230/20; F05B 2280/5007

(57) ABSTRACT

A method for manufacturing a wind power plant rotor blade is provided. A mold for manufacturing at least a part of the wind power plant rotor blade is prepared. The mold has a recess, which is used to manufacture at least a part of the wind power plant rotor blade. Liquid erosion protection material is introduced into the recess. Fiber layers are placed in the recess of the mold after the liquid erosion protection material has at least partially hardened. A vacuum infusion bag or a vacuum infusion film is placed, and a vacuum infusion is performed with a resin, so as to obtain a composite component at least as part of the wind power plant rotor blade.

### BACKGROUND

### Technical Field

The present invention relates to a method for manufacturing a wind power plant rotor blade as well as to a wind power plant rotor blade.

### Description of the Related Art

Rotor blades of a wind power plant are constantly exposed to changing weather conditions, which can result in damage to the rotor blades of the wind power plant. In order to reduce damage to the rotor blades of the wind power plant, it is known to apply an erosion protection film to the surface of the rotor blade. Alternatively thereto, the rotor blade can be provided with erosion protection afterwards by applying an erosion protection material with rollers or brushes. However, it is disadvantageous to use an erosion protection film that has to be adhesively bonded to the surface of the rotor blade afterwards, or to use a liquid erosion protection agent that must be applied to the surface of the rotor blade with rollers or brushes, because this can impair the aerodynamic surface of the rotor blade. In addition, applying the erosion protection to the surface of the rotor blade is likewise time-intensive.

The German Patent and Trademark Office searched the following documents in the priority-establishing German patent application: US 2019/0153995 A1, US 2017/0058865 A1, US 2017/0145988 A1, DE 10 2015 115 190 A1, DE 10 2013 108 358 A1, DE 10 2008 055 479 A1, DE 10 2016 213 206 A1, EP 2 708 740 A1, WO 2012/113 966 A1, and WO 2016/030 170 A1.

### BRIEF SUMMARY

Provided is a method for manufacturing a wind power plant rotor blade that enables an improved erosion resistance of the rotor blade.

A method for manufacturing a wind power plant rotor blade is thus provided. A mold is prepared for manufacturing at least a part of the wind power plant rotor blade. The mold has a recess, which is used to manufacture at least a part of the wind power plant rotor blade. Liquid erosion protection material is introduced into the recess. Fiber layers are placed in the recess of the mold after the liquid erosion protection material has at least partially hardened. A vacuum infusion bag or a vacuum infusion film is placed, and a vacuum infusion is performed with a resin, so as to obtain a composite component at least as part of the wind power plant rotor blade.

The use of a liquid erosion protection material makes it possible to better adjust the erosion protection material to the contours of the recess of the mold, The liquid material penetrates better even into complex contours of the recess of the mold, and ensures a better erosion protection even in complex contours. In addition, both air pockets and resin pockets can be avoided between the mold and erosion protection material. The liquid erosion protection material is likewise more process reliable, since the liquid erosion protection material cannot slip in the mold. The liquid erosion protection material further allows a faster, and hence more cost-effective, processing.

According to an aspect of the present invention, an erosion protection material (for example, in liquid form) is introduced into a mold for manufacturing a wind power plant rotor blade. After the erosion protection material has at least partially dried or hardened, fiberglass layers can be inserted into the mold as usual, so as to manufacture the rotor blade. A vacuum infusion process is then performed, so that the erosion protection material as well as the fiberglass layers and epoxy resin combine, yielding a rotor blade comprised of composite material with already integrated erosion protection in the area of the leading edge.

According to an aspect of the present invention, the leading edge is located in the deepest area of the mold, so that the erosion protection material is provided in the area of the leading edge.

According to an aspect of the present invention, leading edge caps with integrated erosion protection material can be provided.

The method can thus be used to manufacture a wind power plant rotor blade, wherein an optimal erosion protection is achieved, in particular in the area of the rotor blade leading edge. An improved contour accuracy of the component can further be achieved, even after longer operation.

Provided is a wind power plant rotor blade with a rotor blade leading edge, a rotor blade trailing edge, a rotor blade root area, and a rotor blade tip area. The rotor blade root area can be used to fasten the rotor blade to a hub of a wind power plant. Provided in the area of the rotor blade leading edge is a composite component, which is manufactured in a vacuum infusion method, and has a hardened erosion protection material as well as fiber layers. The erosion protection material at least partially represents the outer surface of the composite component, and hence of the rotor blade leading edge.

Additional configurations of the invention are the subject of the subclaims.

### BRIEF DESCRIPTION OF THE SEVERAL VIEWS OF THE DRAWINGS

Advantages and exemplary embodiments of the invention will be described in more detail below with reference to the drawing.

FIG. 1 shows a schematic illustration of a wind power plant according to an aspect of the present invention,

FIG. 2 shows a schematic illustration of a wind power plant rotor blade according to an aspect of the present invention,

FIG. 3 shows a schematic sectional view of a mold during the manufacture of a wind power plant rotor blade according to an aspect of the present invention, and

FIG. 4 shows a schematic partial sectional view of a wind power plant rotor blade according to an aspect of the present invention.

### DETAILED DESCRIPTION

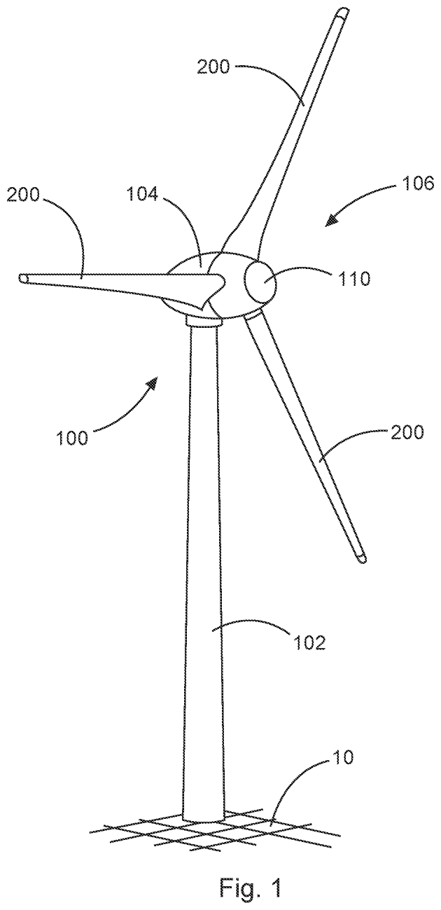

FIG. 1 shows a schematic illustration of a wind power plant according to an aspect of the present invention. The wind power plant 100 has a tower 102 and a nacelle 104 on the tower 102. An aerodynamic rotor 106 with three rotor blades 200 and a spinner 110 is provided on the nacelle 104. The aerodynamic rotor 106 is made to rotate by the wind during operation of the wind power plant, and thus also turns a rotor or runner of a generator, which is directly or indirectly coupled with the aerodynamic rotor 106. The electric generator is arranged in the nacelle 104, and generates electric energy. The pitch angles of the rotor blades 108 can be varied by pitch motors on the rotor blade roots 108b of the respective rotor blades 108.

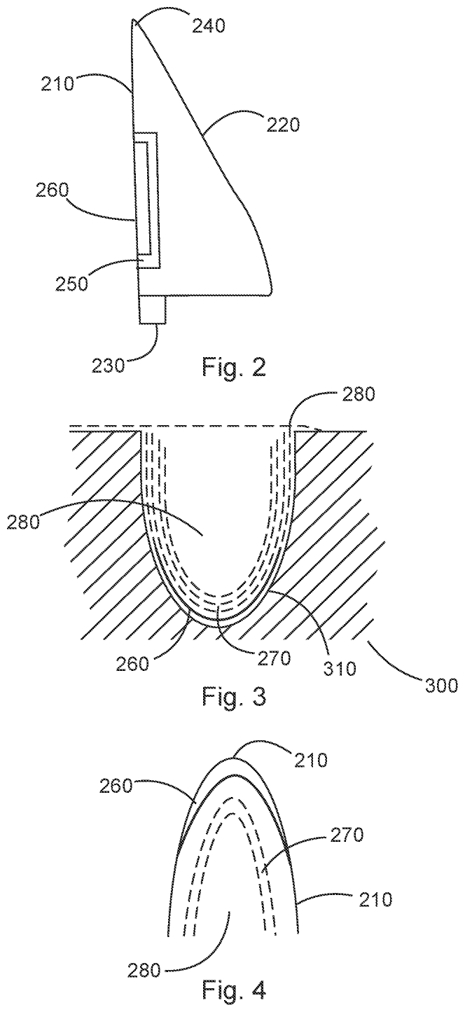

FIG. 2 shows a schematic illustration of a wind power plant rotor blade according to an aspect of the present invention. The rotor blade 200 has a rotor blade leading edge 210, a rotor blade trailing edge 220, a rotor blade root area 230 and a rotor blade tip 240. The rotor blade root area 230 can be used to fasten the rotor blade to a hub of the wind power plant. The rotor blade further has a rotor blade front cap 250, which can have an erosion protection material 260. The erosion protection material 260 at least partially represents the surface of the rotor blade, in particular in the area of the rotor blade leading edge 210. The rotor blade leading edge 210 or the rotor blade front cap 250 can be configured at least partially as a fiber composite component, wherein the erosion protection material at least partially represents the surface of the fiber composite component. In particular, the fiber composite component can be manufactured by means of a vacuum infusion method, wherein the erosion protection material is part of the composite component.

FIG. 3 shows a schematic sectional view of a mold during the manufacture of a wind power plant rotor blade according to an aspect of the present invention. FIG. 3 shows a mold 300 that is used for manufacturing a rotor blade according to an aspect of the present invention. For this purpose, the mold 300 has a recess 310, into which the fiber layers (fiberglass or carbon fibers) for manufacturing the rotor blade of the wind power plant are inserted.

According to an aspect of the present invention, a liquid erosion protection material 260 is introduced first (i.e., before the fiber(glass) layers 270 are inserted). This can be done with a brush or roller (for example, this can be done with a flat brush). After the erosion protection material 260 has sufficiently hardened, fiber(glass) layers 270 can be inserted into the mold, so that at least a part of the rotor blade can be formed. Finally, a vacuum infusion is performed, so that a component comprised of composite material is manufactured out of the erosion protection material 260, the inserted fiber(glass) layers 270 and (for example) epoxy resin 280, or a composite material component is manufactured that can be used to manufacture the rotor blade of the wind power plant.

For example, the erosion protection material can be 6D1100 from Bergolin or ALEXIT LE Protect 443-EE from Mankiewicz. The time required to harden the erosion protection material can measure between 10 minutes (min.) and 60 min., for example.

After the fiberglass layers have been inserted into the mold accordingly, a vacuum infusion bag or film 280 can be placed thereover, and a vacuum infusion can be performed, during which in particular epoxy resin is introduced by vacuum infusion, and then hardened, thereby yielding a composite component.

FIG. 4 shows a schematic partial sectional view of a wind power plant rotor blade. The rotor blade 200 has a rotor blade leading edge 210. Hardened erosion protection material 260 is provided at least partially in the area of the rotor blade leading edge 210. The rotor blade leading edge further has fiber layers, which were manufactured with a vacuum infusion method and (for example) epoxy resin.

One aspect of the present invention provides a method for manufacturing a wind power plant rotor blade. A liquid erosion protection material is introduced into a mold for manufacturing a rotor blade, which serves in particular for manufacturing the rotor blade leading edge, so that in particular the rotor blade leading edge is thereby formed. After the liquid erosion protection material has sufficiently hardened, fiberglass layers or carbon layers are placed in the mold. A vacuum infusion bag is subsequently placed over the mold, and a vacuum infusion in particular of epoxy resin is performed, so as to yield a composite component as part of the rotor blade.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for manufacturing a wind power plant rotor blade, the method comprising:
preparing a mold for manufacturing at least a part of the wind power plant rotor blade, wherein the mold has a recess;
introducing liquid erosion protection material into the recess;
placing fiber layers into the recess of the mold after the liquid erosion protection material has at least partially hardened;
placing a vacuum infusion bag or a vacuum infusion film over the mold; and
performing a vacuum infusion with a resin to obtain a composite component, thereby manufacturing the at least part of the wind power plant rotor blade.

2. The method for manufacturing a wind power plant rotor blade according to claim 1, wherein the composite component includes a rotor blade leading edge, and wherein the erosion protection material is located in an area of the rotor blade leading edge.

3. A wind power plant rotor blade, comprising:
a rotor blade leading edge, a rotor blade trailing edge, a rotor blade root area, and a rotor blade tip area;
hardened erosion protection material; and
fiber layers;
wherein the hardened erosion protection material and the fiber layers form a composite component.

4. The wind power plant rotor blade according to claim 3, wherein the hardened erosion protection material and the fiber layers is manufactured in a vacuum infusion method to form the composite component.

5. The wind power plant rotor blade according to claim 3, wherein the hardened erosion protection material is located in an area of the rotor blade leading edge.

6. The wind power plant rotor blade according to claim 3, wherein the fiber layers are fiberglass layers.
